(19) United States
(12) Patent Application Publication
(10) Pub. No.: US 2013/0110355 A1
(43) Pub. Date: May 2, 2013

(54) CONTROL SYSTEM AND METHOD OF RADAR AND VISION SYSTEMS FOR VEHICLE APPLICATIONS

(71) Applicants: Dong-il CHO, Seoul (KR); Jaehong Park, Seoul (KR); Wonsang Hwang, Seoul (KR); Hyunil Kwon, Ulsan (KR); Jong-hyeon Kim, Jeji-do (KR); Changhun Lee, Gyeonggi-do (KR)

(72) Inventors: Dong-il CHO, Seoul (KR); Jaehong Park, Seoul (KR); Wonsang Hwang, Seoul (KR); Hyunil Kwon, Ulsan (KR); Jong-hyeon Kim, Jeji-do (KR); Changhun Lee, Gyeonggi-do (KR)

(73) Assignee: SNU R&DB FOUNDATION

(21) Appl. No.: 13/282,244

(22) Filed: Oct. 26, 2011

(51) Int. Cl. G06F 7/00

(52) U.S. Cl. 701/49

(57) ABSTRACT

Provided are a direction control system and a method of a radar system or a vision system mounted in a vehicle. The direction control system of the radar and vision system for a vehicle according to an embodiment includes: an inertial sensor system and a handle steering angle sensor system which detect posture and movement information regarding a vehicle; a control unit which generates a control signal on the basis of the posture and movement information regarding the vehicle detected by the inertial sensor system and the handle steering angle sensor system; first and second driving units which are driven according to the control signal of the control unit; and a radar system and a vision system which are respectively connected to the first and second driving units.

### BACKGROUND

1. Field

The present disclosure relates to a direction control system and a method of a radar or vision system mounted in a vehicle, and more particularly, a system and a method for, in a case where a vehicle is moved according to the situation of a road and the intention of a driver, generating a signal corresponding to the posture and movement of the vehicle using an inertial sensor system, a handle steering angle sensor system, and the like mounted in the vehicle, and controlling a direction of a radar and vision system mounted in a vehicle to a desired direction according to the generated signal.

2. Description of the Related Art

The development of a technique for mounting a radar or vision system and the like in a vehicle to enhance stability of a vehicle drive has been made for the convenience of driver.

When the radar or vision system is fixed and mounted at a predetermined position of the vehicle, it is difficult for the driver to obtain desired information due to straight propagation of light input to the radar or vision system. Therefore, in order for the driver to easily obtain the desired information, a unit for controlling a direction by the radar or vision system mounted in the vehicle is required.

### SUMMARY

The present disclosure is directed to provide a system and a method for perceiving the movement of a vehicle using an inertial sensor system, a handle steering angle sensor system, and the like mounted in the vehicle, and a controlling a direction of a radar and vision system included in the moving vehicle according to the situation of a road and the intention of a driver using the information.

The inertial sensor system is a sensor system which is configured of an accelerometer and an angular velocity sensor and is able to perceive the posture and movement information regarding a vehicle. The handle steering angle sensor system means a system that is able to measure the rotation angle of the handle of the vehicle and perceive the posture and movement information regarding the vehicle on the basis of the angle.

In addition, in the present disclosure, besides the two sensor systems, the posture and movement information regarding a vehicle may be perceived using a vehicle velocity sensor system, a transmission state monitoring system, and the like together. As described above, the information of the inertial sensor system and the handle steering angle sensor system are used singly or in combination to perceive the movement information regarding the vehicle, and this information is used as feedforward information or feedback information to control the direction of the radar system and the vision system mounted in the vehicle to a desired direction. In addition, through this, in a distance maintaining system or adaptive cruise control (ACC) system to which the radar system or the vision system is applied, when a preceding vehicle is out of the range of vision of the radar system or the vision system due to road environments or the intention of the driver, the direction of the radar system and the vision system is controlled on the basis of the posture and the movement information regarding the vehicle, and the range of vision of the radar system and the vision system is maintained to include the preceding vehicle, thereby consistently obtaining information needed for a vehicle drive.

The present disclosure relates to the method and the system for controlling the direction of the radar system or the vision system mounted in the vehicle to a desired direction; however, this disclosure may also be applied to control a direction of an object detecting system having directivity such as an ultrasonic sensor system as well as the above-mentioned systems to a desired direction.

In one aspect, there is provided a direction control system of a radar and vision system for a vehicle, including: an inertial sensor system and a handle steering angle sensor system which detect posture and movement information regarding a vehicle; a control unit which generates a control signal on the basis of the posture and movement information regarding the vehicle detected by the inertial sensor system and the handle steering angle sensor system; first and second driving units which are driven according to the control signal of the control unit; and a radar system and a vision system which are respectively connected to the first and second driving units, of which the direction is changed by driving of the first and second driving units, and which are mounted in the vehicle to collect information regarding a vehicle drive.

The inertial sensor system may include an accelerometer, an angular velocity sensor, and a circuit for signal processing and signal transmission of each of the sensors.

The handle steering angle sensor system may include a system which detects a rotation angle of a handle and calculates the posture and movement information regarding the vehicle.

The direction control system of the radar and vision system for a vehicle may further include a vehicle velocity sensor system and a transmission state monitoring system which are mounted in the vehicle and assist in calculating the posture and movement information regarding the vehicle.

The first driving unit may include one or more driving shafts to move the radar system in an axial direction or rotate the radar system relative to the axial direction.

The second driving unit may include one or more driving shafts to move the vision system in an axial direction or rotate the vision system relative to the axial direction.

The control unit may control the first driving unit and the second driving unit according to posture and movement characteristics of the vehicle, using the posture and movement information regarding the vehicle detected from the signals of the inertial sensor system and the handle steering angle sensor system as a feedforward signal.

The control unit may control the first driving unit and the second driving unit according to posture and movement characteristics of the vehicle, using the signals detected by the inertial sensor system and the handle steering angle sensor system as a feedforward signal and using the signals transmitted from the radar system and the vision system as a feedback signal.

In another aspect, there is provided a direction control method of a radar and vision system for a vehicle, including: generating, by an inertial sensor system and a handle steering angle system, a signal by detecting a posture or movement of a vehicle; receiving, by a control unit, the signal of the inertial sensor system and the handle steering angle system as a feedforward signal; and controlling, by the control unit, the radar system and the vision system to direct a direction set in advance according to the posture and movement information regarding the vehicle.

The direction control method of the radar and vision system for a vehicle may further include: generating information regarding a preceding vehicle or obstacles detected by the radar system and the vision system; and transmitting the generated information to the control unit as a feedback signal.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a block diagram showing the configuration of a direction control system of a radar and vision system for a vehicle according to an embodiment;

FIG. 2 is a flowchart of a direction control method of the radar and vision system for a vehicle according to an embodiment;

FIG. 3 is a diagram schematically showing the direction control system of the radar and vision system applied to a vehicle according to an embodiment; and

FIG. 4 is a diagram showing an example of applying the direction control system of the radar and vision system for a vehicle to a distance maintaining system or an adaptive cruise control system according to an embodiment.

### DETAILED DESCRIPTION

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity.

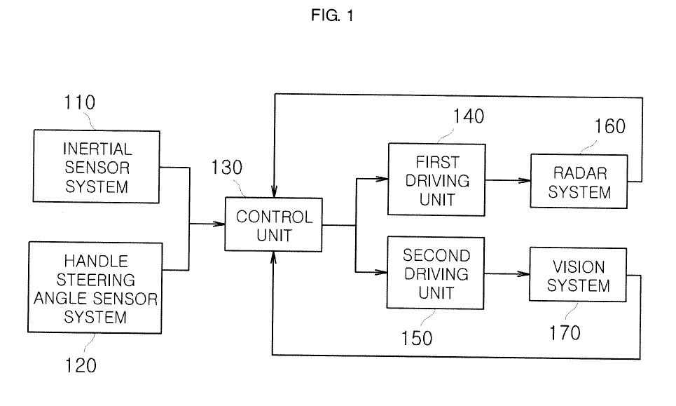

FIG. 1 is a block diagram showing the configuration of a direction control system of a radar and vision system for a vehicle according to an embodiment.

Referring to FIG. 1, the direction control system of the radar and vision system for a vehicle according to an embodiment includes an inertial sensor system 110 and a handle steering angle sensor system 120 for detecting the posture and movement information regarding the vehicle, a control unit 130, a first driving unit 140, a second driving unit 150, a radar system 160 connected to the first driving unit 140, and a vision system 170 connected to the second driving unit 150.

The direction control system of the radar and vision system for a vehicle according to an embodiment may include a plurality of parts connected to each other. As shown in FIG. 1, signals of the inertial sensor system 110 and the handle steering angle sensor system 120 may be used as feedforward signals, and signals of the radar system 160 and the vision system 170 may be used as feedback signals to perform direction control.

In addition, according to another embodiment, although not shown in the figure, direction control may be performed using a single signal from among the inertial sensor system signals and the handle steering angle sensor system signals, and besides the inertial sensor system 110 and the handle steering angle sensor system 120, a vehicle velocity sensor system, a transmission state monitoring system, and the like may be added to perceive the posture and movement information regarding the vehicle.

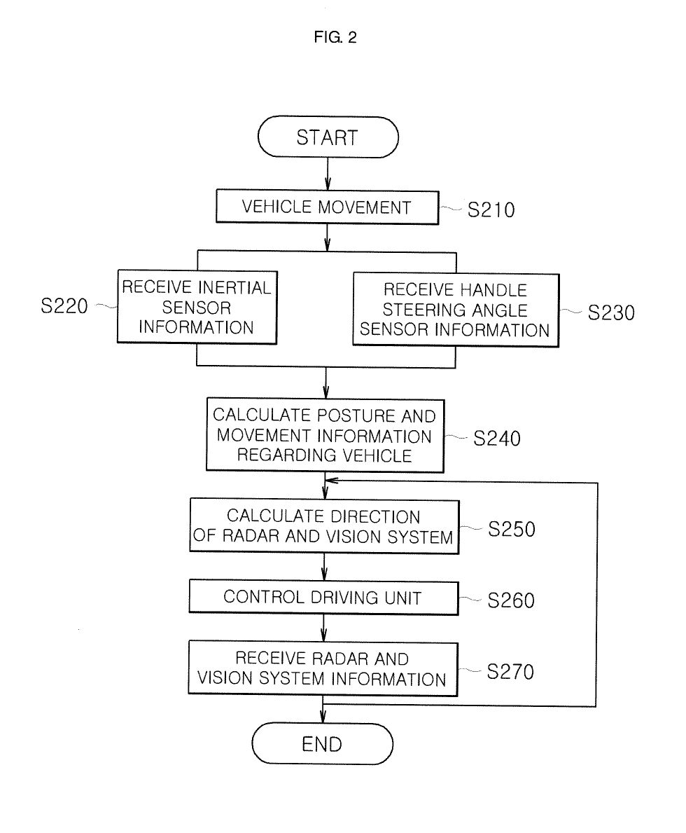

FIG. 2 is a flowchart of a direction control method of the radar and vision system for a vehicle according to an embodiment.

Referring to FIG. 2, in the direction control method of the radar and vision system for a vehicle according to this embodiment, a vehicle movement is started (S210), information of the inertial sensor system 110 and the handle steering angle sensor system 120 which is generated according to the movement of the vehicle is received (S220 and S230).

Subsequently, the posture and movement information regarding the moving vehicle on the basis of the received information is calculated (S240), a desired direction of the radar system 160 and the vision system 170 mounted in the vehicle is calculated on the basis of the calculated information (S250), and the calculated direction information is transmitted to the first driving unit 140 and the second driving unit 150, thereby finally controlling the direction of the radar system 160 and the vision system 170 (S260).

In addition, as shown in FIG. 2, information obtained by the radar system 160 and the vision system 170 may be applied as a feedback signal (S270), and although not shown in the figure, the direction control may be performed using only the signals of the inertial sensor system 110 and the handle steering angle sensor system 120. In addition, besides the inertial sensor system 110 and the handle steering angle sensor system 120, using information of a vehicle velocity sensor system, a transmission state monitoring system, and the like, the posture and movement information regarding the vehicle may be calculated. When the movement of the vehicle is stopped, the process is ended.

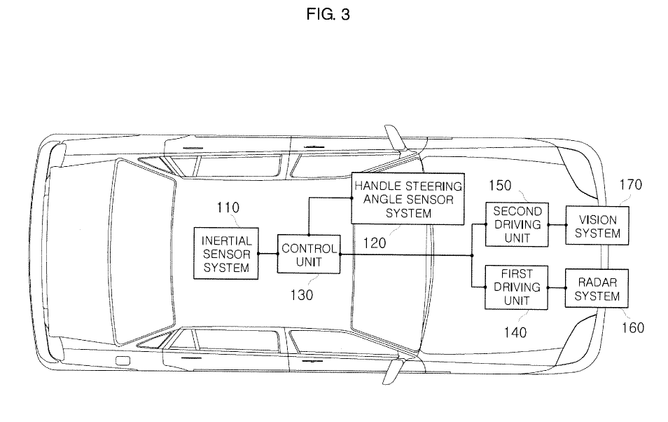

FIG. 3 is a diagram schematically showing the direction control system of the radar and vision system applied to a vehicle according to an embodiment.

Referring to FIG. 3, the direction control system of the radar and vision system of this embodiment includes the inertial sensor system 110, the handle steering angle sensor system 120, the control unit 130, the first driving unit 140, the second driving unit 150, the radar system 160 connected to the first driving unit 140, and the vision system 170 connected to the second driving unit 150, which are mounted in the vehicle.

Specifically, the inertial sensor system 110 is configured of an accelerometer, an angular velocity sensor, and a circuit for processing the sensor signals. The handle steering angle sensor system 120 is a system that is able to detect the degree of rotation of the handle by the driver. Although not shown in the figure, in order to perceive the posture and movement information regarding the vehicle, the vehicle velocity sensor system, the transmission state monitoring system, and the like may be combined for use.

The control unit 130 has a function of calculating the direction of the radar system 160 and the vision system 170 on the basis of the posture and movement information regarding the vehicle and generating a control signal for controlling the driving units 140 and 150. The control unit 130 may employ methods such as a proportional control method, the fuzzy theory, a genetic algorithm, and a neural network in order to generate the control signal by combining the signals of the various sensor systems.

The driving units 140 and 150 has a function of receiving the control signal of the control unit 130 and changing the direction of the radar system 160 and the vision system 170. The radar system 160 and the vision system 170 for perceiving the information regarding a preceding vehicle are connected to the driving units 140 and 150 to change the direction according to the road situations.

In order to change the direction of the radar system 160 and the vision system 170, each of the entire systems may be connected to the driving units 140 and 150, and parts that are included in the systems such as an antenna of the radar system 160 and a vision sensor of the vision system 170 may be connected to the driving units 140 and 150.

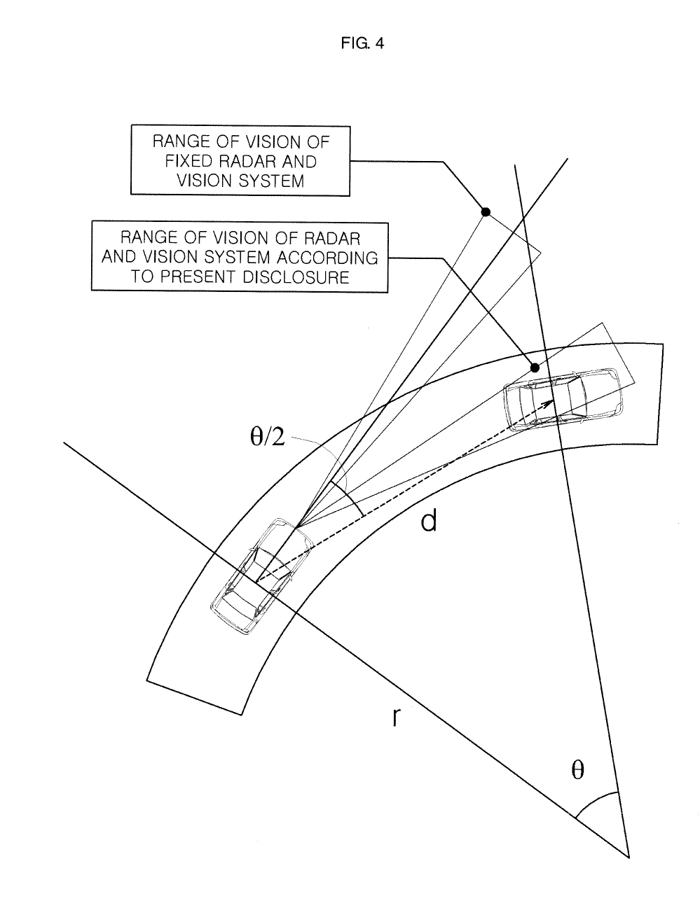

FIG. 4 is a diagram showing an example of applying the direction control system of the radar and vision system for a vehicle to a distance maintaining system or an adaptive cruise control system according to an embodiment.

As shown in FIG. 4, when the vehicle runs on a curved road, there may be cases where a preceding vehicle disappears from the range of vision of the radar system 160 or the vision system 170 of a vehicle that follows the preceding vehicle depending on the radius of curvature (r) of the curved road and the distance (d) between the vehicles. In this case, when the direction control system of the radar and vision system for a vehicle that is proposed by the disclosure is applied, the direction of the radar system 160 and the vision system 170 is controlled to the direction of the preceding vehicle on the basis of the posture and movement information regarding the vehicle, so that the position and distance information regarding the preceding vehicle is consistently obtained during a drive on a curved road.

When the direction control system and the method of the radar and vision system for a vehicle according to this disclosure are used, the posture and movement information regarding the vehicle is perceived using the inertial sensor system, the handle steering angle system, and the like, and the driving units are controlled on the basis of this, thereby adjusting a direction of the radar system and the vision system to a desired direction in consideration of the road environments and the intent of a driver and consistently maintaining the desired direction.

In addition, when the system and the method according to this disclosure are applied to a distance maintaining system or an adaptive cruise control system, in a case where a preceding vehicle disappears from the range of vision of the radar system or the vision system of a moving vehicle due to the road environments and the intent of the driver, the direction of the radar system and the vision system is controlled on the basis of the posture and movement information regarding the vehicle, thereby consistently positioning the preceding vehicle in the range of vision of the radar system and the vision system.

While the exemplary embodiments have been shown and described, it will be understood by those skilled in the art that various changes in form and details may be made thereto without departing from the spirit and scope of the present disclosure as defined by the appended claims.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A direction control system of a radar and vision system for a vehicle, comprising:
an inertial sensor system and a handle steering angle sensor system which detect posture and movement information regarding a vehicle;
a control unit which generates a control signal on the basis of the posture and movement information regarding the vehicle detected by the inertial sensor system and the handle steering angle sensor system;
first and second driving units which are driven according to the control signal of the control unit; and
a radar system and a vision system which are respectively connected to the first and second driving units, of which the direction is changed by driving of the first and second driving units, and which are mounted in the vehicle to collect information regarding a vehicle drive.

2. The direction control system according to claim 1, wherein the inertial sensor system includes an accelerometer, an angular velocity sensor, and a circuit for signal processing and signal transmission of each of the sensors.

3. The direction control system according to claim 1, wherein the handle steering angle sensor system includes a system which detects a rotation angle of a handle and calculates the posture and movement information regarding the vehicle.

4. The direction control system according to claim 1, further comprising a vehicle velocity sensor system and a transmission state monitoring system which are mounted in the vehicle and assist in calculating the posture and movement information regarding the vehicle.

5. The direction control system according to claim 1, wherein the first driving unit includes one or more driving shafts to move the radar system in an axial direction or rotate the radar system relative to the axial direction.

6. The direction control system according to claim 1, wherein the second driving unit includes one or more driving shafts to move the vision system in an axial direction or rotate the vision system relative to the axial direction.

7. The direction control system according to claim 1, wherein the control unit controls the first driving unit and the second driving unit according to posture and movement characteristics of the vehicle, using the posture and movement information regarding the vehicle detected from the signals of the inertial sensor system and the handle steering angle sensor system as a feedforward signal.

8. The direction control system according to claim 1, wherein the control unit controls the first driving unit and the second driving unit according to posture and movement characteristics of the vehicle, using the signals detected by the inertial sensor system and the handle steering angle sensor system as a feedforward signal and using the signals transmitted from the radar system and the vision system as a feedback signal.

9. A direction control method of a radar and vision system for a vehicle, comprising:
generating, by an inertial sensor system and a handle steering angle system, a signal by detecting a posture or movement of a vehicle;
receiving, by a control unit, the signal of the inertial sensor system and the handle steering angle system as a feedforward signal; and
controlling, by the control unit, the radar system and the vision system to direct a direction set in advance according to the posture and movement information regarding the vehicle.

10. The direction control method according to claim 9, further comprising:
generating information regarding a preceding vehicle or obstacles detected by the radar system and the vision system; and
transmitting the generated information to the control unit as a feedback signal.
